(19) United States
(12) Patent Application Publication
(10) Pub. No.: US 2009/0112453 A1
(43) Pub. Date: Apr. 30, 2009

(54) METHOD OF PROVIDING DIRECTION INFORMATION ACCORDING TO REAL-TIME TRAFFIC CONDITIONS

(75) Inventors: Sung-Wook Mo, Seoul (KR); Young-Gon Seo, Seoul (KR); Myoung-Jin Shin, Seoul (KR); Byung-Ik Ahn, Gyeonggi-do (KR); Won-Tae Kim, Gyeonggi-do (KR)

Correspondence Address: KNOBBE MARTENS OLSON & BEAR LLP, 2040 MAIN STREET, FOURTEENTH FLOOR, IRVINE, CA, 92614, US

(73) Assignees: KTFreetel Co. LTD., Seoul (KR); NEIGHBOR SYSTEM CO., LTD, Seoul (KR); POINT-I CO., LTD., Seoul (KR)

(21) Appl. No.: 12/343,315

(22) Filed: Dec. 23, 2008

Related U.S. Application Data
(63) Continuation of application No. PCT/KR2007/003003, filed on Jun. 21, 2007.

(30) Foreign Application Priority Data
Jun. 27, 2006 (KR) 10-2006-0058221

(51) Int. Cl. G08G 1/00; G01C 21/00

(52) U.S. Cl. 701/119; 701/117; 701/201

(57) ABSTRACT

A method, device and recorded medium having recorded the method, for providing directions information applied with real-time traffic condition reports are disclosed. An aspect of the present invention features a method and device that can receive traffic condition reports in real-time and provide directions information applied with the pertinent traffic condition reports. Accordingly, with the present invention, the directions information can be generated by using first real-time traffic condition reports. Then, the path directions applied with the change of traffic condition reports according to the time flow can be acquired and provided to a user.

### RELATED APPLICATIONS

This application is a continuation application, and claims the benefit under 35 U.S.C. §§ 120 and 365 of PCT Application No. PCT/KR2007/003003, filed on Jun. 21, 2007, which is hereby incorporated by reference.

### BACKGROUND

1. Field of the Invention

The field relates to providing direction information, more specifically to a method, device and recorded medium having instructions for providing direction information with real-time traffic condition reports.

2. Description of the Related Technology

Conventionally, an apparatus for providing traffic condition reports performs path computation, and a terminal downloads the computed path directions through a communication network. In accordance with this method, after requesting and downloading path directions to a destination, a user is unable to apply changed traffic condition reports to the path directions. To apply the changed traffic condition reports, it is necessary that a re-searching operation is carried out without the request of the user. However, this causes additional access time, thereby increasing unnecessary access, and system load. In addition, since all searched accident information is transferred to all users, unnecessary information can be transferred to some users (e.g. the information related to the accident occurring in one city is transferred to the user driving in another city), and the unnecessary information can be considered as a spam mail.

A terminal itself may be equipped with functions such as path searching in a navigation system. If a separate network access apparatus such as a FM data radio channel (FM DAR) receiver or a TPEG receiving module has path searching built in the navigation system, the traffic condition reports can be received in real-time. However, the navigation system may also include functions of receiving current traffic condition reports and searching corresponding path directions. The navigation system stores path directions, computes a path, and periodically re-computes the path directions taking into account the traffic condition reports changed compared to the previously computed path directions.

### SUMMARY OF CERTAIN INVENTIVE ASPECTS

One aspect is a method of providing direction information in real time. The method includes receiving path directions request information from a terminal, generating direction information corresponding to the path directions request information, transmitting the generated direction information to the terminal, receiving path directions re-searching request information including remaining path directions, re-computing the path directions based on traffic condition reports according to the path directions re-searching request information, and if the re-computed path directions are different from the remaining path directions, re-generating direction information and transmitting the re-generated direction information to the terminal.

Another aspect is a device for providing direction information in real-time. The device includes a data transmitting and receiving unit, configured to receive traffic condition reports from at least one traffic condition report center, and to receive path directions request information or path directions re-searching request information from a terminal. The device also includes a traffic condition report database, configured to store the traffic condition reports, and a direction information generating unit, configured to generate direction information by computing path directions corresponding to the path directions request information or the path directions re-searching request information, and to generate renewed direction information by including speed information and time information, corresponding to the computed path directions, where the data transmitting and receiving unit is configured to transmit the generated direction information and the renewed direction information to the terminal.

Another aspect is a method for a terminal to receive direction information in real-time from a device through a communication network. The method includes acquiring actual driving speed information based on location change of the terminal at time intervals, generating path directions request information including start information and destination information, transmitting the generated path directions request information to the device, receiving direction information corresponding to the path directions request information from the device, generating guide information based on the direction information, outputting the guide information on a display, determining whether to re-search path directions by using actual driving speed information and the directions information, generating path directions re-searching request information including remaining path directions, sending the generated path directions re-searching request information to the device, receiving renewed direction information according to the path directions re-searching request information, generating renewed guide information based on the renewed direction information, and displaying the renewed guide information.

Another aspect is a terminal configured to receive direction information in real-time from a device through a communication network. The terminal includes a transmitting and receiving unit, configured to receive direction information from the device, a location acquiring unit, configured to acquire actual driving speed information corresponding to the location change of the terminal, and a processor, configured to compare the actual driving speed information with the direction information, to determine whether to re-search path directions, to compute remaining path directions, and to generate path directions re-searching request information including the computed remaining path directions. The transmitting and receiving unit is further configured to transmit the path directions re-searching request information to the device and to receive renewed direction information corresponding to the path directions re-searching request information.

Another aspect is a method for a terminal to receive traffic condition reports from a traffic condition report center and to generate directions information. The method includes receiving a path directions generating command including start and destination information, computing path directions and direction information in response to the path directions generating command, the path directions including speed information and estimated driving time information, acquiring actual driving speed information, comparing the actual driving speed information with the direction information, and, if the difference between the actual driving speed information and the directions information is equal to or greater than a speed reference value, applying the traffic condition reports to re-compute the path directions.

Another aspect is a computer readable medium having instructions, which, when executed in a terminal, which is connected to a device for providing direction information through a communication network, cause the terminal to perform a method. The method includes acquiring actual driving speed information according to the location change of the terminal at intervals of time, generating path directions request information including start information and destination information, transmitting the generated path directions request information to the device for providing directions information, receiving direction information corresponding to the path directions request information, generating guide information based on the direction information, outputting the guide information through a display, determining whether to re-search path directions by using actual driving speed information and the direction information, and if it is determined to re-search the path directions, generating path directions re-searching request information including remaining path directions, transmitting the path directions re-searching request information to the device for providing directions information, receiving renewed direction information, where the renewed direction information is renewed according to the path directions re-searching request information, generating renewed guide information based on the renewed direction information, and displaying the renewed guide information.

One aspect provides a method, device and recorded medium having the method of providing direction information according to real-time traffic condition reports that can generate path directions by using first real-time traffic condition reports. Subsequently, the method recalculates the path directions according to the updated real-time traffic condition reports, which may have changed. The recalculated path directions are then provided to the user.

Some aspects also provide a method, device and recorded medium having recorded the method, for providing direction information according to the change of real-time traffic condition reports. This can allow a terminal to help avoid a traffic jam by providing traffic jam information including a traffic jam section and speed information of the traffic jam section.

Some aspects provide a method, device and recorded medium having the method of providing direction information according to the change of real-time traffic condition reports. This can allow a terminal to have a receiving module for receiving additional traffic condition reports and to directly receive traffic condition reports through a traffic condition report server, such as TPEG, DARC and CBS. Other traffic condition reports may also be used.

Some aspects provide a method, device and recorded medium having the method of providing direction information according to the change of real-time traffic condition reports. This can make it unnecessary to individually manage direction information of a terminal and decrease the load of a traffic condition server by allowing the terminal to determine a point of time for re-searching traffic conditions for a path and to transmit the point of time to the traffic condition server.

Another aspect includes a method and device of providing direction information, where the method can re-generate and transmit direction information in response to a re-searching request from a terminal.

According to one aspect, a method includes a device providing direction information in real time, receiving a path direction request from a terminal, generating direction information according to the request, transmitting the generated direction information to the terminal, receiving path directions, re-searching based on the request further path directions, re-computing the path directions in light of traffic condition reports according to the path directions re-searching request information, and if the re-computed path directions are different from the path directions, re-generating direction information and transmitting the re-generated directions information to the terminal.

According to another aspect, a device for providing direction information provides direction information in real-time. The device includes a data transmitting and receiving unit, receiving traffic condition reports from at least one traffic condition report center, and receiving path directions request information or path directions re-searching request information from a terminal; a traffic condition report database, storing the traffic condition reports; and a directions information generating unit, configured to compute path directions corresponding to the path directions request information or the path directions re-searching request information, and generating renewed directions based on speed information and time information, corresponding to the computed path directions, whereas the generated direction information can be transmitted to the terminal through the data transmitting and receiving unit.

Another aspect includes a terminal, providing direction information in real-time, a method, providing direction information and a recorded medium, having recorded a program being readable by the terminal.

According to one aspect, a method includes a terminal, connected to a device for providing direction information through a communication network, receiving direction information in real-time, including acquiring actual driving speed information according to the location change of the terminal at time intervals; generating path directions request information including start information and destination information and transmitting the generated path directions request information to the device for providing directions information; receiving direction information corresponding to the path directions request information, generating guide information and outputting the guide information through a display; determining whether to re-search path directions by using the actual driving speed information and the direction information, if it is determined to re-search the path directions, generating path directions re-searching request information including remaining path directions to the device for providing direction information; and receiving renewed directions information according to the path directions re-searching request information, and generating guide information and displaying the guide information.

According to another aspect, a terminal, which is connected to a device for providing directions information through a communication network, receives direction information in real-time, including a transmitting and receiving unit, and receives direction information from the device for providing directions information. The device includes a location acquiring unit, acquiring actual driving speed information corresponding to the location change of the terminal; and a processor, comparing the actual driving speed information with the direction information and determining whether to re-search path directions. If it is determined to re-search the path directions, the device computes remaining path directions and generates path directions re-searching request information including the computed remaining path directions, whereas the processor transmits the path directions re-searching request information to the device for providing direction information through the transmitting and receiving unit and receives renewed direction information corresponding to the path directions re-searching request information through transmitting and receiving unit.

According to another aspect a method includes a terminal, connected to at least one of traffic condition report center through a communication network, receiving traffic, condition reports from the traffic condition report center and generating direction information, including receiving a path directions generating command including start and destination information; computing path directions corresponding to the path directions generating command, including predetermined speed information and estimated driving time information in the computed path directions and generating directions information; and acquiring actual driving speed information and comparing the actual driving speed with the direction information, and if the difference between the actual driving speed information and the direction information is the same as or larger than a reference value, applying the traffic condition reports and re-computing the path directions.

According to another aspect, a recorded medium having recorded a program configured to be executed in a terminal, which is connected to a device for receiving direction information through a communication network, for providing directions information in real-time, the recorded medium being readable by the terminal, including acquiring actual driving speed information according to the location change of the terminal at intervals of a predetermined time; generating path directions request information including start information and destination information and transmitting the generated path directions request information to the device for providing direction information; receiving direction information corresponding to the path directions request information, generating guide information and outputting the guide information through a display; determining whether to re-search path directions by using actual driving speed information and the direction information, if it is determined to re-search the path directions, generating path directions re-searching request information including remaining path directions to the device for providing direction information; and receiving direction information renewed according to the path directions re-searching request information, generating guide information and displaying the guide information.

### BRIEF DESCRIPTION OF THE DRAWINGS

FIG. 1 is a block diagram illustrating a system for providing traffic condition reports in accordance with some embodiments; an embodiment of the present invention;

FIG. 2 is a block diagram illustrating an internal structure of a device for providing direction information in accordance with some embodiments;

FIG. 3 is a block diagram illustrating an internal structure of a terminal in accordance with some embodiments;

FIG. 4 is a flow chart illustrating a method that a device for providing direction information provides direction information to a terminal connected through a communication network in accordance with some embodiments;

FIG. 5 is a flow chart illustrating an operation that a terminal requests direction information corresponding to traffic condition reports and receives the direction information from a device for providing direction information in accordance with some embodiments;

FIG. 6 is an example illustrating renewed direction information corresponding to path directions re-searching request information outputted in a screen of a terminal in accordance with some embodiments;

FIG. 7 is a block diagram briefly illustrating an internal structure of a terminal in accordance with some embodiments;

FIG. 8 is a flow chart illustrating a method for providing direction information in accordance with some embodiments; and

FIG. 9 is a flow chart illustrating a method that a device for providing direction information provides traffic jam information to a terminal connected through a communication network in accordance with some embodiments;

### DETAILED DESCRIPTION OF THE INVENTION

Some embodiments provide a method, device and recorded medium having recorded the method, for providing direction information according to the change of real-time traffic condition reports and can generate path directions by using first real-time traffic condition reports, and then, acquires the path directions applied with the real-time traffic condition reports changed according to the change of time, and provide the new path directions to a user.

Some embodiments also allow a terminal to help avoid a traffic jams by providing traffic jam information including a traffic jam section and speed information of the traffic jam section.

Some embodiments also allow a terminal to be equipped with an additional traffic condition report receiving module and to directly receive traffic condition reports through one or more traffic condition report services in addition to a traffic condition report server, to generate path directions.

In addition, some embodiments make it unnecessary to individually manage direction information of a terminal and decrease the load of a traffic condition report providing server by allowing the terminal to determine a point of time for re-searching a path and to transmit the point of time to the traffic condition report providing server.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals.

Hereinafter, preferred embodiments will be described in detail with reference to the accompanying drawings. Identical or corresponding elements will be given the same reference numerals, regardless of the figure number, and any redundant description of the identical or corresponding elements will not be repeated. Throughout the description of the present invention, when describing a certain technology is determined to evade the point of the present invention, the pertinent detailed description will be omitted.

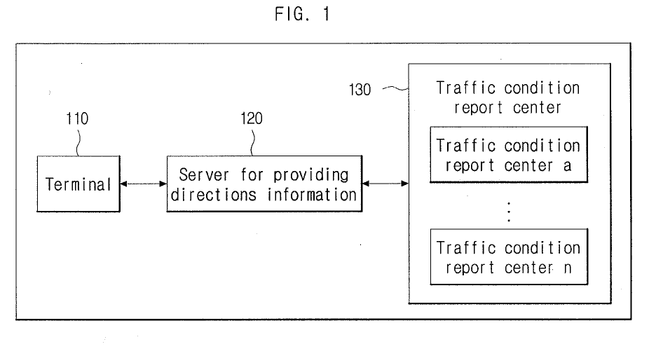

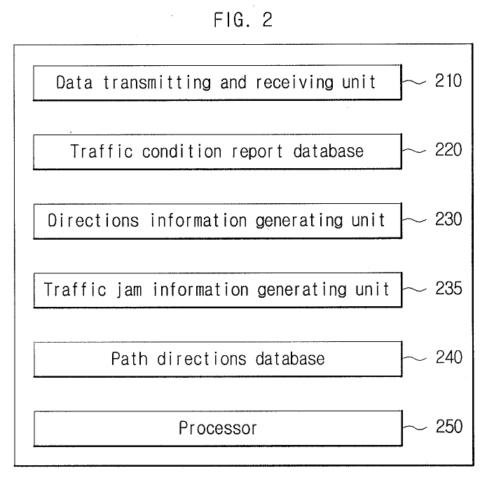

FIG. 1 is a block diagram briefly illustrating a system for providing traffic condition reports in accordance with an embodiment, and FIG. 2 is a block diagram briefly illustrating an internal structure of a device for providing directions information in accordance with some embodiments.

Referring to FIG. 1, in accordance with some embodiments, a system for providing traffic condition reports includes a terminal 110, a device for providing directions information 120 and a plurality of traffic condition report centers 130.

The terminal 110 can be inside-mounted with means, such as a global positioning system (GPS), capable of acquiring a location, or can connected to external location acquiring means to acquire a location.

For example, the terminal 110 has to acquire start location information, destination location information and current location information, to compute or request path directions.

In some methods for acquiring, location information is divided into a method using a GPS receiver and a cell method using a repeater through a wireless network. Accordingly, it is not necessarily required that the terminal 110 is inside-mounted or equipped with the GPS receiver, to acquire location information. The location information can be also acquired though a cell method. Of course, other methods for acquiring the location can be applied. This description is based on a method for acquiring the location information by using a GPS receiver. In other words, the description refers to the terminal 110 as being inside-mounted with a GPS receiver.

Here, the GPS receiver typically computes location information by using time and distance information received by 3 or more satellites at intervals of time and transfers the computed location information to the terminal 110. The GPS receiver can compute and transmit to the terminal 110 speed information as well as the location information.

The terminal 110 can include various types of terminals, such as portable mobile terminals, bluetooth terminals and portable Internet terminal, capable of wireless data communication. Particularly, the terminal 110 can be equipped with a navigation function or can be connected to a separate navigation kit. The description is based on a terminal 110 equipped with the navigation function.

The device for providing direction information 120, which is connected to the terminal 110 through a communication network, provides direction information according to the request of the terminal 110. Also, the device 120 can receive traffic condition reports from the plurality of traffic condition report centers 130 and make a database for the traffic condition reports. Here, the traffic condition reports can include accident information related to traffic jam occurring corresponding to traffic accident and road construction, for example.

Referring to FIG. 2, the device for providing direction information 120 includes a data transmitting and receiving unit 210, a traffic condition report database 220, a directions information generating unit 230, a traffic jam information generating unit 235, a path directions database 240 and a processor 250.

The data transmitting and receiving unit 210 receives traffic condition reports from the plurality of traffic condition report centers 130 and transfers the received traffic condition reports to the traffic condition report database 220 according to the control of the processor 250.

The data transmitting and receiving unit 210 also receives path directions request information and path direction re-searching request information and transmits them to the direction information generating unit 230 according to the control of the processor 250. Beside that, the data transmitting and receiving unit 210 transmits to the terminal 110 the direction information, generated in the directions information generating unit 230, according to the control of the processor 250.

The traffic condition report database 220 stores the traffic condition reports input from the data transmitting and receiving unit 210 according to the control of the processor 250. For example, the device for providing direction information 120 stores traffic condition reports, received from the plurality of traffic condition report centers 130 during a period of time. It is also possible that the traffic condition reports are stored in a separate storing area or are deleted, a period of time (e.g. a day or 12 hours) after being stored in the traffic condition report database 220. Since the traffic condition reports, used at the very time when the path directions is computed, of the traffic condition reports used for computing the path directions is valid, the earlier traffic condition reports can be separately managed or deleted. Of course, in accordance with a method, the traffic condition reports can be stored in a separate storing device or area during a period of time. Then, with the lapse of time, the traffic condition reports can be stored in the traffic condition report 220. As such, valid traffic condition reports can be more quickly searched by managing the traffic condition reports, used at substantially the time when the path directions are computed, separately from the earlier traffic condition reports.

The direction information generating unit 230 can extract from a path directions table, path directions related to start and destination information corresponding to the path directions request information and the path directions re-searching request information, which are received from the terminal 110 and input through data transmitting and receiving unit 210 by the control of the processor 250. Also, the direction information generating unit 230 can generate the direction information including speed information on the extracted path directions. Here, the direction information generating unit 230 can extract traffic condition reports, on the path directions, from the traffic condition report database 220 and apply the extracted traffic condition reports, to compute the path directions.

The path directions database 240 stores a node of each area, a road map represented by use of a link between the nodes and estimated driving time information between each node (i.e. each link).

For the convenience of description and understanding, the method that the direction information generating unit 230 extracts path directions from the path directions database 240, corresponding to traffic condition reports and generates path directions will be briefly described.

The direction information generating unit 230 can compute at least one path direction by extracting a node and a link, connected from start to destination, from the path directions database 240 by use of start information and destination information, received from the terminal 110. The direction information generating unit 230 can also apply traffic condition reports to the extracted path directions and compute shortest distance, shortest time and optimized path directions, respectively. Here, the direction information generating unit 230 transmits the extracted path directions, including estimated driving time information of each node (i.e. each link), to the processor 250.

The traffic jam information generating unit 235 can generate traffic jam information including and traffic jam section and speed information of the traffic jam section, corresponding to the path directions re-searching request information, received from the terminal 110, by the control of the processor 250. Here, the path directions re-searching request information can include remaining path directions and an actual driving speed.

The processor 250 controls internal elements (e.g. the data transmitting and receiving unit 210, the traffic condition report database 220, the direction information generating unit 230 and the path directions database 240) of the device for providing direction information 120 in accordance with some embodiments.

In addition, the processor 250 can compare an actual driving speed included in the path directions re-searching request information, received through the terminal 110, with a driving speed on the path directions, to determine whether there is a traffic jam at a corresponding section. If it is determined that there is a traffic jam at the section, the processor 250 controls the traffic jam information generating unit 235 to generate traffic jam information.

As described above, the device for providing direction information 120 receives traffic condition reports from the plurality of traffic condition report centers 130 and stores the traffic condition reports. Also, the device 120 can generate and provide direction information corresponding to the path directions requesting information or the path directions re-searching request information.

Referring to FIG. 1, the traffic condition report centers 130 gather and distribute traffic condition reports including accident information.

In addition, the traffic condition report centers 130 may periodically transmit gathered traffic condition reports to the device for providing direction information 120 at intervals of a regular time. Particularly, in the case of transmitting traffic condition reports to the device for providing directions information 120, the traffic condition report centers 130 can transmit the traffic condition reports including predetermined identity information to the device 120 such that the device 120 can identify the accident information. Of course, according to some embodiments, the traffic condition report centers 130 can transmit traffic condition reports and accident information in different forms, respectively, to the device 120 in order to identify the accident information and the traffic condition reports.

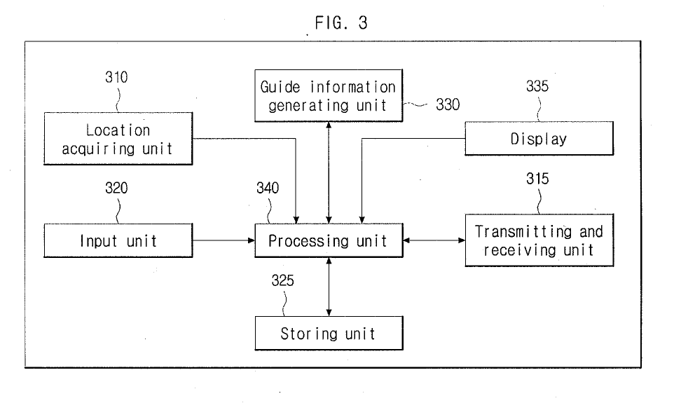

FIG. 3 is a block diagram illustrating an internal structure of a terminal for providing direction information in accordance with some embodiments. The terminal 100 can provide direction information by linking with the device for providing directions information 120.

Referring to FIG. 3, the terminal 110 includes a location acquiring unit 310, a transmitting and receiving unit 315, an input unit 320, a storing unit 325, a guide information generating unit 330, a display 335 and a processing unit 340.

The location acquiring unit 310 acquires location information according to the change of the location of the terminal 110 at intervals of time and computes a driving speed by use of the acquired location information to transfer it to the processing unit 340. For example, the location acquiring unit 310 can be a GPS receiver. Although this description assumes that location acquiring unit 310 is a GPS receiver, the location information can additionally or alternatively be acquired by using a base station.

The transmitting and receiving unit 315 transmits and receives data to and from the device for providing directions information 120 by the control of the processing unit 340. For example, the transmitting and receiving unit 315 can transmit path directions request information including start and destination information, input from a user, and path directions re-searching request information to the device 120 through a communication network by the control of the processing unit 340. Also, the transmitting and receiving unit 315 can receive from the device 120 the direction information generated corresponding to the pertinent path directions request information or the path directions re-searching request information and transfer the received directions information to the guide information generating unit 330 by the control of the processing unit 340.

The input unit 320 is means for inputting a control command, for controlling the operation of the terminal 110, and a function selecting command (e.g. a starting command for driving according to path directions). For example, the input unit 320 can be realized as a plurality of buttons (e.g. a menu button or a function button) or in a form of touch screen.

The storing unit 325 stores direction information, received from the device 120, speed information, acquired from the location acquiring unit 310, and operating system of the terminal 110 in accordance with some embodiments, by the control of the processing unit 340.

The guide information generating unit 330 generates guide information for a navigation service by using the location information, input from the location acquiring unit 310, and the direction information, received from the device 120, by using the control of the processing unit 340. Here, the guide information, which is generated by a method using the direction information or the renewed directions information, received from the device 120, and the actual driving speed information, acquired from the location acquiring unit 310, can guide advancing directions toward the destination.

The display 335 is means for outputting, for example, direction information and guide information, corresponding to the navigation service. For example, the display 340 can be a liquid crystal display (LCD).

The processing unit 340 controls internal elements (e.g. the location acquiring unit 310, the transmitting and receiving unit 315, the input unit 320, the storing unit 325, the guide information generating unit 330 and the display 335) of the terminal 110 in accordance with an embodiment of the present invention.

The controlling unit 340 compares an actual driving speed, acquired through the location acquiring unit 310, with the driving speed included in the direction information, received from the device for providing direction information 120. If the actual driving speed is less than the driving speed included in the direction information, the processing unit 340 can transmit the request to re-search the path directions to the device 120.

In addition, the processing unit 340 can compute a current driving time by using the actual driving speed, acquired through the location acquiring unit 310. Then, the processing unit 340 can compare the computed current driving time information with estimated driving time information of the current node (i.e. section of each area) in the direction information, received from the device 120 and determine whether to re-search the path directions, to transmit the request to re-search the path directions to the device 120.

For example, the processing unit 340 compares the computed current driving time information with estimated driving time information of the current node in the direction information. If the computed current driving time is slower than a minimum time, the processing unit 340 can transmit the request to re-search the path directions to the device 120.

As described above, the terminal 110 can be linked with the device for providing directions information 120 and receive and output direction information, renewed corresponding to the request to re-search the path directions.

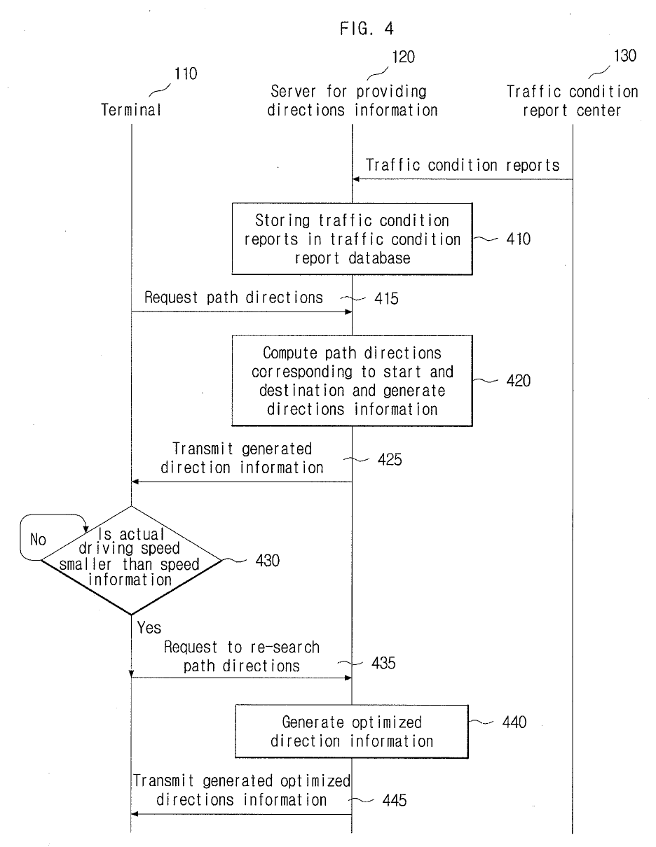

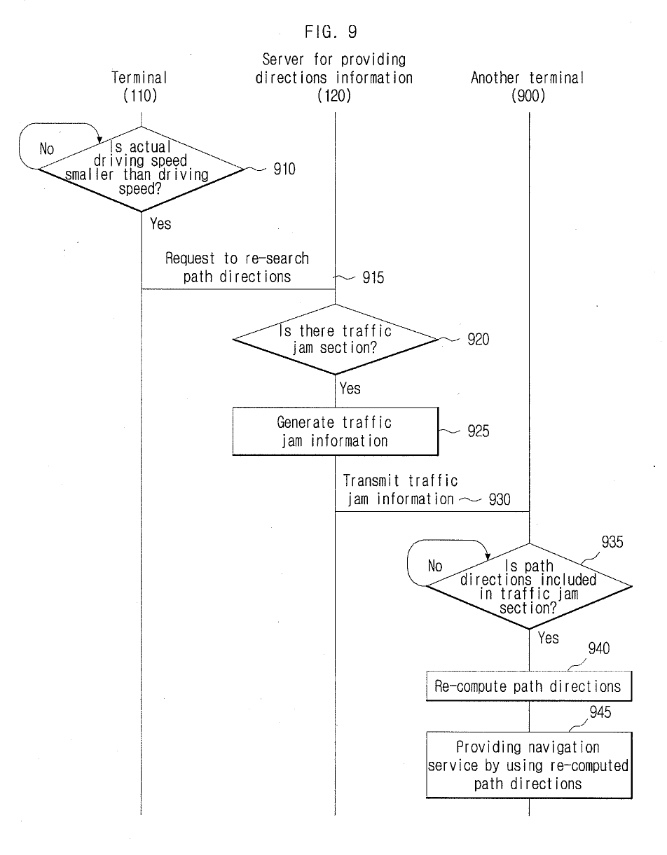

FIG. 4 is a flow chart illustrating a method that a device for providing direction information provides direction information to a terminal connected through a communication network in accordance with an embodiment of the present invention, and FIG. 9 is a flow chart illustrating a method that a device for providing direction information provides traffic jam information to a terminal connected through a communication network in accordance with an embodiment of the present invention. The below description includes that the device for providing direction in formation 120 periodically receives traffic condition reports from the plurality of traffic condition reports 130 at regular or irregular intervals of a time and stores the received traffic condition reports in the traffic condition report database 220. For convenience of description and understanding, although the steps to be described below are performed in the functional blocks, respectively, of the device for providing direction information 120, each of the functional blocks will be referred to as the device for providing directions information 120 in the below description.

In step 410 of FIG. 4, the device for providing direction information 120 receives traffic condition reports from the plurality of traffic condition report centers 130 and makes a database for the received traffic condition reports. Here, the device 120 can periodically receive the traffic condition reports from the plurality of traffic condition report centers 130 at intervals of a predetermined time and make a database for the received traffic condition reports.

In step 415, the device 120 receives path directions request information, including start and destination information, from the terminal 110 through a network. Here, the start information can be location information of the current area, acquired through a location acquiring device (not shown) such as a GPS receiver by the terminal 110, and the destination information can be destination location information including a location, an address and a building of the destination.

In step 420, the device 120 computes path directions for arriving at the destination in a shortest time among a variety of path directions between the start and the destination, included in the path directions request information received from the terminal 110, by using the traffic condition reports pre-received from the traffic condition report centers 130. The device 120 can compute optimized path directions in addition to the path directions for arriving at the destination in the shortest time. This description includes that the device 120 computes and outputs the path directions for arriving at the destination in the shortest time. The device 120 can compute path directions without being applied with the traffic condition reports and provide the path directions to the terminal 110 through a communication network. As such, the device 120 can compute the path directions between the start and the destination, and then, generate direction information including speed information corresponding to the computed path directions and provide the directions information to the terminal 110 through the communication network, in step 425. This can allow the terminal 110 to provide a navigation service to a user by using direction information received from the device 120.

In step 430, the terminal 110 acquires or computes current driving speed information and compares actual driving speed with the speed included in the direction information received from the device 120 through the communication network.

Here, the terminal 110 computes the cumulative average of the driving speed acquired at intervals of a time during a regular period of time and compares the computed cumulative average with the speed information included in the direction information. If the distance between the cumulative average and the speed information is larger than a value, it can be determined that the traffic condition reports are changed. Accordingly, the terminal 110 can decrease an error caused by the speed acquired corresponding to a speed drop, due to a standby time of the traffic light, and slow moving traffic (e.g. 4 km/h or less).

As the result of comparing, if the actual driving speed is less than the cumulative average, in step 435, the terminal 110 transfers the path directions re-searching request information to the device 120 though the communication network. Here, the terminal can transmit remaining path directions as well as the path directions re-searching request information together. Accordingly, since it is not necessary to store the path directions of the terminal 110, the device 120 is not requested to manage the path directions of the terminal 110, to thereby reduce the load.

In step 440, the device 120 re-computes a variety of path directions by using the traffic condition reports received from the traffic condition report centers 130 corresponding to remaining path directions. The device 120 generates and transmits to the terminal 110 direction information including speed information corresponding to the path directions according to the shortest time, in step 445. The directions information including the re-computed path directions will be referred to as “renewed direction information.”

As described above, without separately managing the path directions, respectively, of the terminal 110, the device 120 can receive the remaining path directions from the terminal 110 and re-compute the path directions according to the request to re-search the path directions to transmit it to the terminal 110 through the communication network. This can considerably decrease the load of the device 120.

A method using the device for providing directions information 120, which has received the request to re-search the path directions, generates traffic jam information and transmits it to another terminal 900 in step 435 will be described with reference to FIG. 9.

The description defines that “traffic jam information” includes information for determining whether there is traffic jam at a pertinent section corresponding to the path directions re-searching request information received through the terminal 110 or 700 (hereinafter, referred to as 110) and being transmitted to another terminal (i.e. at least another terminal 900, except for the terminal transmitting the path directions re-searching request information, which receives traffic condition reports from the device 120).

In step 920, the device 120 determines whether there is traffic jam at an section on path directions included in path directions re-searching request information.

For example, the device 120 can determine whether there is a traffic jam at the section by applying the traffic condition reports received at intervals of a time and stored.

If it is determined that there is a traffic jam at the section, in step 925, the device 120 generates traffic jam information. Here, the traffic jam information can include traffic jam section and speed information of the traffic jam section.

In step 930, the device 120 transmits the generated traffic jam information to another terminal 900. Here, the terminal 900 can be the terminal receiving the traffic condition reports from the device 120. The device 120 can additionally store access information (e.g. IP address) of the terminal 900 for transmitting traffic jam information.

In step 935, if the traffic jam information is received through the device 120, the terminal 900 determines whether a traffic jam section is included in the direction information that is under a navigation service.

If it is determined that the traffic jam section is included in the path directions that is being been provided, in step 940, the terminal 900 re-computes the path directions by applying the traffic jam information.

In step 945, the terminal 900 provides the navigation service to a user by using the re-computed path directions.

As described above, the device 120 can guide the user to avoid the traffic jam section and to drive by providing the traffic jam section to the terminal 900 that receives traffic condition reports.

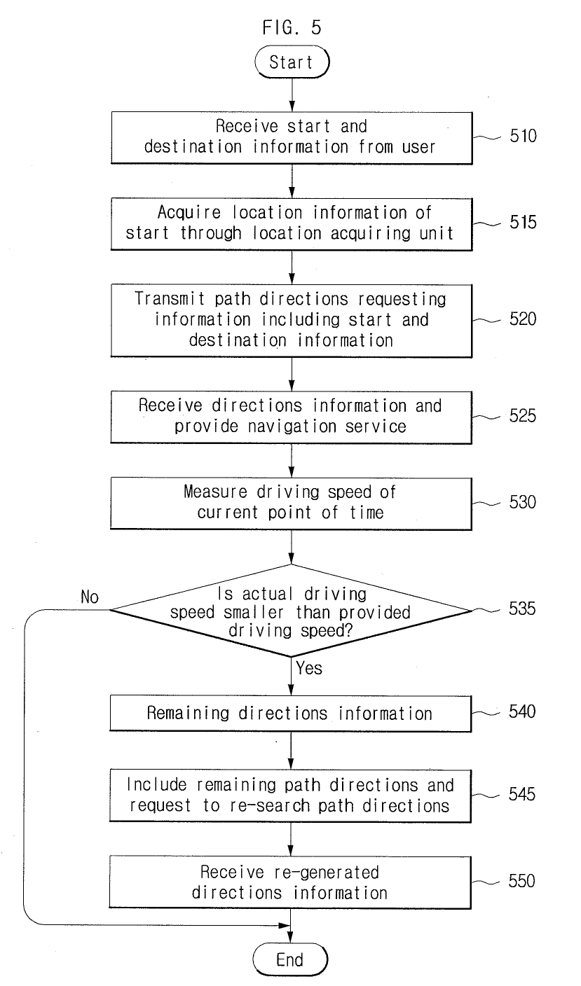

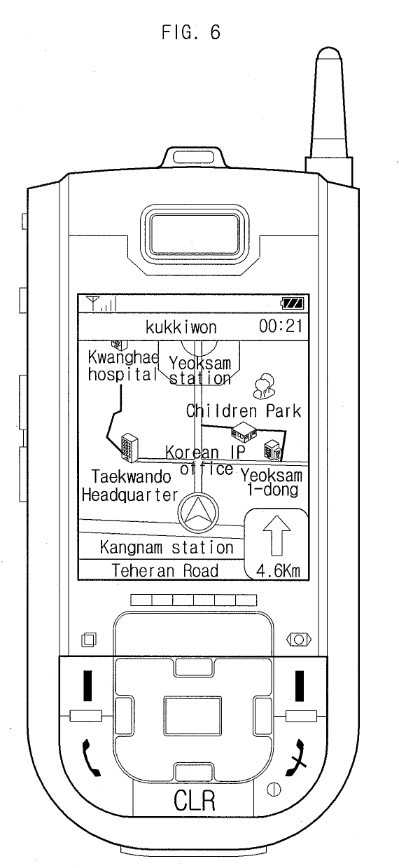

FIG. 5 is a flow chart illustrating an operation that a terminal requests direction information corresponding to traffic condition reports and receives the directions information from a device for providing directions information in accordance with some embodiments, and FIG. 6 is an example illustrating renewed directions information corresponding to path directions re-searching request information outputted in a screen of a terminal in accordance with some embodiments.

In step 510, the terminal 110 is inputted with start information and destination information from a user. Also, the terminal 110 acquires location information (e.g. location coordinate information) of a current point of time through a provided location acquiring unit in a step represented by 515. For example, the terminal 110 can inside-mount the location acquiring unit such as a GPS receiver and receive location information from a satellite providing a location.

In step 520, the terminal 110 generates and transmits to the device for providing direction information 120 path directions request information including the acquired location information of the current point of time, the start information and the destination information.

In step 525, the terminal 110 receives from the device 120 direction information corresponding to the path directions request information. By using this, the terminal 110 can provide navigation service by using an intern application.

In step 530, the terminal 110 computes an actual driving speed. For example, the terminal 110 can compute the actual driving speed by using the location information acquired by the location acquiring unit 310. In other words, the actual driving speed can be computed by using a distance moved during a time.

In step 535, the terminal 110 compares the computed actual driving speed with a driving speed on the path directions included in the direction information received from the device 120.

If the actual driving speed is less than the driving speed, in step 540, the terminal 110 generates remaining path directions different from path directions guided from the direction information.

In step 545, the terminal 110 generates path directions re-searching request information including the remaining path directions and transmits it to the device 120. Here, the remaining path directions can be the information including location information of an area, located with the terminal 110, and destination information. The remaining path directions can be the information including all remaining path directions except for path directions guided from direction information, earlier transmitted from the device 120.

In step 550, the terminal 110 receives optimized direction information corresponding to the path directions re-searching request information from the device 120. Also, the terminal 110 can provide navigation service to a user by using the received optimized direction information. FIG. 6 is an example illustrating renewed direction information corresponding to path directions re-searching request information output in a screen of a terminal in accordance with some embodiments.

Here, the terminal 110 repeats the steps 530 through 550 until reaching the destination.

As described above, in the method for providing direction information in accordance with various embodiments, the terminal 110 can determine a point of time when the path directions is re-searched and transmit the request to re-search the path directions to the device 120. Also, the load of the device 120 can be reduced by allowing the terminal 110 to manage the path directions.

The description of FIG. 5 is based on embodiments where the terminal 110 compares the actual speed with the direction information (i.e. estimated speed) and determines whether to re-search the path directions, to transmit the request to re-search the path directions to the device 120. However, in another embodiment, the terminal 110 can compute an actual driving time of the current node (i.e. section). Then, the terminal 110 can determine whether to re-search the path directions by extracting and comparing the computed actual driving time and the estimated driving time of the current node.

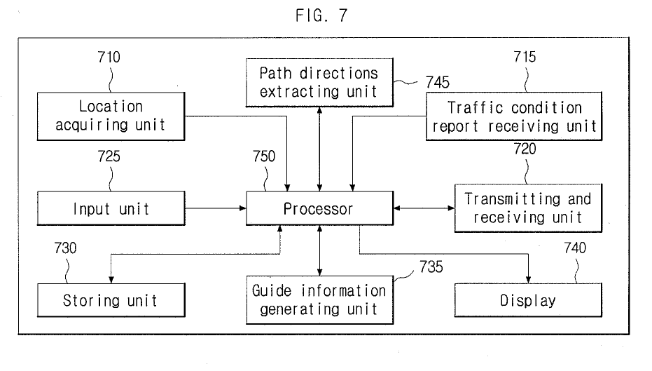

FIG. 7 is a block diagram illustrating an internal structure of a terminal in accordance with some embodiments. A terminal 700 can receive traffic condition reports from the traffic condition report centers 130 at intervals of time. Then, the terminal 700 can compute direction information by using the received traffic condition reports. Some elements are similar to corresponding elements shown in FIG. 3.

Referring to FIG. 7, a traffic condition report receiving unit 715 receives traffic condition reports from one or more traffic condition report services at intervals of time (or in real-time) and transfers the received traffic condition reports to a processor 750. Here, the traffic condition report receiving unit 715 can be equipped with a receiving unit for receiving the traffic condition reports from the traffic condition report centers 130, respectively.

A path direction extracting unit 745 can extract path directions, corresponding to the start and destination information input from an input unit 725, from a path directions table.

Accordingly, the terminal 700 can receive the traffic condition reports from the traffic condition report centers 130 in real-time and compute path directions applied with the pertinent traffic condition reports. Then, the terminal 700 can transfer optimized path directions to a guide information generating unit 735 by the control of the processor 750.

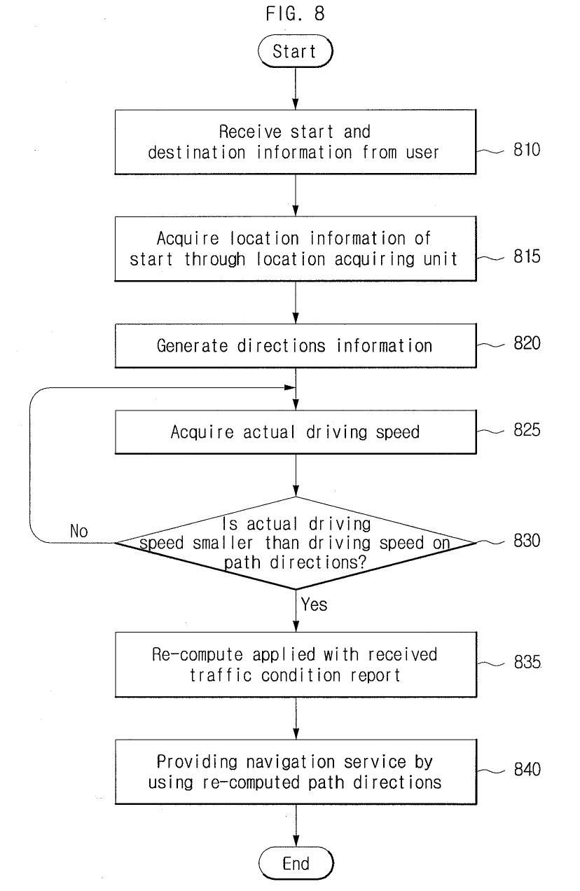

FIG. 8 is a flow chart illustrating a method of providing direction information in accordance with some embodiments. The below description is based on the case that the terminal 700 receives traffic condition reports from the traffic condition report centers 130 in real-time and computes path directions applied with the pertinent traffic condition reports, to provide optimized path directions. Here, steps 810 and 815 may be similar to aforementioned steps.

In step 820, the terminal 700 computes path directions by using the acquired location information of the current point of time and the inputted start information and the destination information, to provide navigation service. Here, the terminal 700 can be have an application for the navigation service in advance.

The terminal 700 computes an actual driving speed in step 825 and compares the computed actual driving speed with a driving speed on the path directions included in the pre-provided direction information in step 830. If the actual driving speed is less than the driving speed of the direction information, the terminal 700 applies the received traffic condition reports and re-computes the path directions, in step 835. If remaining path directions are different from the re-computed path directions, the terminal 700 provides the navigation service applied with the recomputed path directions to a user in step 840.

Hitherto, although some embodiments of the present invention have been shown and described with the above-described details, it will be appreciated by any person of ordinary skill in the art that a large number of modifications, permutations and additions are possible within the principles and spirit of the invention.

What is claimed is:

1. A method of providing direction information in real time, the method comprising:
receiving path directions request information from a terminal;
generating direction information corresponding to the path directions request information;
transmitting the generated direction information to the terminal;
receiving path directions re-searching request information including remaining path directions; and
re-computing the path directions based on traffic condition reports according to the path directions re-searching request information, and if the re-computed path directions are different from the remaining path directions, re-generating direction information and transmitting the re-generated direction information to the terminal.

2. The method of claim 1, wherein the path directions request information comprises current location information, start information and destination information.

3. The method of claim 1, wherein generating the direction information corresponding to the path directions request information and the transmitting of the generated directions information to the terminal comprises:
computing the path directions according to the path directions request information; and
generating direction information including speed information and estimated driving time information between nodes, corresponding to the computed path directions, and transmitting the generated direction information to the terminal,
wherein the nodes each represent an area.

4. The method of claim 1, further comprising:
generating traffic jam information for the received path directions re-searching information, the traffic jam information including a traffic jam section, speed information, and time information of the traffic jam section; and
transmitting the traffic jam information to another terminal through a communication network.

5. The method of claim 1, further comprising
periodically receiving traffic condition reports from at least one traffic condition report center at intervals of time and storing the received traffic condition reports in a database; and
deleting or storing in another storing area the traffic condition reports after a delay.

6. The method of claim 1, wherein the direction information comprises traffic condition reports for a time when the path directions is requested.

7. A device for providing direction information in real-time, the device comprising:
a data transmitting and receiving unit, configured to receive traffic condition reports from at least one traffic condition report center, and to receive path directions request information or path directions re-searching request information from a terminal;
a traffic condition report database, configured to store the traffic condition reports; and
a direction information generating unit, configured to generate direction information by computing path directions corresponding to the path directions request information or the path directions re-searching request information, and to generate renewed direction information by including speed information and time information, corresponding to the computed path directions,
wherein the data transmitting and receiving unit is configured to transmit the generated direction information and the renewed direction information to the terminal.

8. The device of claim 7, further comprising
a traffic jam information generating unit, configured to generate traffic jam information corresponding to the path directions researching request information, the traffic jam information including traffic jam section information, traffic jam speed information and traffic jam time information.
wherein the data transmitting and receiving unit is configured to transmit the generated traffic jam information to the terminal.

9. A method for a terminal to receive direction information in real-time from a device through a communication network, the method comprising:
acquiring actual driving speed information based on location change of the terminal at time intervals;
generating path directions request information including start information and destination information;
transmitting the generated path directions request information to the device;
receiving direction information corresponding to the path directions request information from the device;
generating guide information based on the direction information;
outputting the guide information on a display;
determining whether to re-search path directions by using actual driving speed information and the directions information;
generating path directions re-searching request information including remaining path directions;
sending the generated path directions re-searching request information to the device;
receiving renewed direction information according to the path directions re-searching request information;
generating renewed guide information based on the renewed direction information; and
displaying the renewed guide information.

10. The method of claim 9, wherein determining whether to re-search path directions and generating the path directions re-searching request information comprises:
comparing actual driving speed information with speed information included in the direction information; and
conditionally generating path directions re-searching request information including remaining path directions on the condition that the actual driving speed information is less than the speed information of the direction information.

11. The method of claim 10, further comprising
computing a cumulative average actual driving speed; and
comparing the computed cumulative average actual driving speed with the speed information included in the direction information.

12. The method of claim 9, wherein the determining whether to re-search path directions and generating the path directions re-searching request information comprises:
computing time information of a current section by using the actual speed information;
comparing the time information of the current section with estimated driving time included in the directions information; and
conditionally generating path directions re-searching request information including remaining path directions on the condition that the time information of the current section is less than the estimated driving time.

13. A terminal configured to receive direction information in real-time from a device through a communication network, the terminal comprising:
a transmitting and receiving unit, configured to receive direction information from the device;
a location acquiring unit, configured to acquire actual driving speed information corresponding to the location change of the terminal; and
a processor, configured to:
compare the actual driving speed information with the direction information;
determine whether to re-search path directions;
compute remaining path directions;
generate path directions re-searching request information including the computed remaining path directions;
wherein the transmitting and receiving unit is further configured to transmit the path directions re-searching request information to the device and to receive renewed direction information corresponding to the path directions re-searching request information.

14. The terminal of claim 13, wherein the direction information comprises at least one of path directions between a start and a destination, speed information for one or more sections, and estimated driving time information for at least one of the sections.

15. The terminal of claim 14, wherein the processor is further configured to compare the actual driving speed information with the speed information in the direction information, and to generate path directions re-searching request information if the actual driving speed information is less than the speed information.

16. The terminal of claim 14, wherein the processor is further configured to compute current driving time information by using the actual driving speed information and to compare the current driving time information with the estimated driving time information, and to generate the path directions re-searching request information if the current driving time information is greater than the estimated driving time information.

17. The terminal of claim 14, further comprising
an input unit, configured to receive the start information and the destination information,
wherein the processor is further configured to generate the path directions request information including the start information and the destination information.

18. The terminal of claim 13, further comprising:
a guide information generating unit, configured to generate guide information based on the direction information or the renewed direction information and the actual driving speed information; and
a display, configured to output the guide information.

19. A method for a terminal to receive traffic condition reports from a traffic condition report center and to generate directions information, the method comprising:
receiving a path directions generating command including start and destination information;
computing path directions and direction information in response to the path directions generating command, the path directions including speed information and estimated driving time information;
acquiring actual driving speed information; and
comparing the actual driving speed information with the direction information, and if the difference between the actual driving speed information and the directions information is equal to or greater than a speed reference value, applying the traffic condition reports to re-compute the path directions.

20. The method of claim 19, wherein comparing the actual driving speed with the direction information comprises comparing the actual driving speed information with speed information of the direction information, and the traffic condition reports is applied to re-compute the path directions comprises if the actual driving speed information is less than the speed information of the direction information.

21. The method of claim 19, wherein acquiring the actual driving speed information and comparing the actual driving speed with the directions information, and applying of the traffic condition reports to re-compute the path directions comprises:
computing current driving time information by using the actual driving speed information; and
applying the traffic condition reports to re-compute the path directions, if the current driving time information is greater than the estimated driving time information and the difference between the current driving time and the estimated driving time information is equal to or greater than a time reference value

22. The method of claim 19, further comprising
receiving traffic condition reports from the traffic condition report center at regular intervals of time,
applying the received traffic condition reports to compute optimized path directions; and
outputting the optimized path directions if the optimized path directions are different from the directions information.

23. The method of claim 19, further comprising
receiving traffic jam information including traffic jam section information;
determining whether the traffic jam section information is included in the computed path directions;
applying the traffic jam information to re-compute path directions; and
transmitting the path directions if the traffic jam section information is included in the computed path directions.

24. A computer readable medium having instructions, which, when executed in a terminal, which is connected to a device for providing direction information through a communication network, cause the terminal to perform a method, the method comprising:
acquiring actual driving speed information according to the location change of the terminal at intervals of time;
generating path directions request information including start information and destination information;
transmitting the generated path directions request information to the device for providing directions information;
receiving direction information corresponding to the path directions request information;
generating guide information based on the direction information;
outputting the guide information through a display;
determining whether to re-search path directions by using actual driving speed information and the direction information;
if it is determined to re-search the path directions, generating path directions re-searching request information including remaining path directions;
transmitting the path directions re-searching request information to the device for providing directions information;
receiving renewed direction information, wherein the renewed direction information is renewed according to the path directions re-searching request information;
generating renewed guide information based on the renewed direction information; and
displaying the renewed guide information.
